(19) United States
(12) Patent Application Publication
(10) Pub. No.: US 2025/0015362 A1
(43) Pub. Date: Jan. 9, 2025

(54) CYLINDRICAL BATTERY AND MANUFACTURING PROCESS THEREOF

(71) Applicant: LANJING NEW ENERGY (JIAXING) CO., LTD., Jiaxing (CN)

(72) Inventors: Chuntai GUO, Jiaxing (CN); Ju WANG, Jiaxing (CN); Shunan FENG, Jiaxing (CN); Wei HE, Jiaxing (CN)

(73) Assignee: LANJING NEW ENERGY (JIAXING) CO., LTD., Jiaxing (CN)

(21) Appl. No.: 18/895,532

(22) Filed: Sep. 25, 2024

Related U.S. Application Data
(63) Continuation of application No. PCT/CN2023/082171, filed on Mar. 17, 2023.

(30) Foreign Application Priority Data
Mar. 28, 2022 (CN) 202210311974.6

(51) Int. Cl. H01M 10/0587; H01M 50/107; H01M 50/143; H01M 50/152; H01M 50/186; H01M 50/536; H01M 50/586

(52) U.S. Cl. CPC H01M 10/0587; H01M 50/107; H01M 50/143; H01M 50/152; H01M 50/186; H01M 50/536; H01M 50/586

(57) ABSTRACT

A cylindrical battery includes a case, and a conductive elastomer, a roll core, a current collector, an insulating element, a cap assembly, and a liquid injection sealing pin sequentially arranged inside the case from bottom to top; a lower portion of the roll core is fixedly connected to the case via the conductive elastomer, an upper portion of the roll core is welded with the current collector, an upper portion of the current collector passes through the insulating element and is welded with the cap assembly, the insulating element is configured to prevent the cap assembly and the roll core from being short-circuited, and an upper portion of the cap assembly is sealed via the liquid injection sealing pin; and a necking and a flange are defined on an outside of the case, a conductive adhesive layer is arranged on an outside of the flange.

### CROSS-REFERENCE TO RELATED APPLICATIONS

This application is a continuation of International Patent Application No. PCT/CN2023/082171 with a filing date of Mar. 17, 2023, designating the United States, now pending, and further claims priority to Chinese Patent Application No. 202210311974.6 with a filing date of Mar. 28, 2022. The content of the aforementioned applications, including any intervening amendments thereto, is incorporated herein by reference.

### TECHNICAL FIELD

The present disclosure belongs to the field of lithium battery technologies, and in particular, relates to a cylindrical battery and a manufacturing process thereof.

### BACKGROUND

The conventional cylindrical battery has a nickel-plated steel case. On the negative side, laser penetration welding is performed on a current collector on the negative electrode and the bottom of the case. In this case, process quality control is difficult, and the nickel texture is damaged by a welding seam. Consequently, the anti-rust capability at the welding seam is poor, and a service life of the battery is shortened. In addition, in the conventional cylindrical battery, the roll core is fastened inside the case only through the rear lower edge of the roll groove. However, fastening of the battery cell through the lower edge of the roll groove becomes unreliable due to increase in the diameter of the battery cell, and the roll core is likely to move axially to affect performance and the service life of the battery cell. Further, the length error of the roll core results in axial movement of the roll core, affecting the service life of the battery. Generally, the cylindrical battery is sealed through the roll groove or laser welding, and laser sealing is low in efficiency and high in cost, improving the manufacturing cost.

### SUMMARY OF THE PRESENT INVENTION

In view of this, an objective of the present disclosure is to disclose a cylindrical battery, to resolve the problems such as a plurality of processing procedures, complex assembling steps, and high cost due to a complex structure of an existing battery.

To achieve the above objective, the present disclosure adopts the following technical solution.

A cylindrical battery includes a case, and a conductive elastomer, a roll core, a current collector, an insulating element, a cap assembly, and a liquid injection sealing pin sequentially arranged inside the case from bottom to top; a lower portion of the roll core is fixedly connected to the case via the conductive elastomer, an upper portion of the roll core is welded with the current collector, an upper portion of the current collector passes through the insulating element and is welded with the cap assembly, the insulating element is configured to prevent the cap assembly and the roll core from being short-circuited, and an upper portion of the cap assembly is sealed via the liquid injection sealing pin; and a necking and a flange are defined on an outside the case, a conductive adhesive layer is arranged on an outside of the flange, and the flange and the cap assembly that are double-seamed, seamed parts of the flange and the cap assembly are positioned above the necking, so that an outer diameter of a sealing edge of a case opening of the case is identical to a diameter of a case body.

Further, thermosetting conductive adhesive layers are arranged on two sides of the conductive elastomer.

Further, a positive sheet tab of the roll core is of a variable-pitch variable-height tab structure to be cut and bent, and is bent and flattened after being wound.

Further, a negative sheet tab of the roll core is of an equal-pitch equal-height multi-tab roll core structure.

Further, the current collector includes a conductive disc and a flange boss that are of an integrated structure, where the flange boss is arranged on a middle part of the conductive disc, a current collector through hole is defined in a middle part of the flange boss, and a sectional area of the conductive disc is smaller than that of the positive sheet tab of the roll core.

Further, the cap assembly includes a cap and a post, where a cap groove is defined on an upper portion of the cap for forming a cap boss on a corresponding position of a lower portion of the cap, a middle part of the cap is riveted with the post, a middle part of the post is defined with a post through hole, and the post and the cap are sealed via an insulated sealing ring.

Further, the post through hole includes an upper groove, a post central liquid-injecting hole, and a lower groove that are of an integrated structure, where the upper groove is welded with the liquid injection sealing pin.

Further, an explosion-proof mechanism is arranged on the cap.

Compared with the prior art, the cylindrical battery defined in the present disclosure has the following advantages:
(1) In the cylindrical battery defined in the present disclosure, the current collector on the negative electrode is cancelled, and the conductive elastomer and the thermosetting conductive adhesives coated on two sides are cured to connect the negative sheet of the battery cell to the case, so that assembling is simple with high assembling efficiency, and the production cost is greatly reduced. Double-seaming is adopted for sealing the positive side, and thermosetting conductive sealant is coated on a contact surface between a flange of a cover plate and a flange of the bottom of the case, so that the sealing effect is good and the production efficiency is high.
(2) The cylindrical battery defined in the present disclosure has a small quantity of battery assembling mechanical parts, a small quantity of laser welding processes, high overall assembling efficiency, and low cost.

Another objective of the present disclosure is to disclose a manufacturing process of a cylindrical battery, to resolve the problems of a plurality of processing processes, complex assembling steps, and high cost of an existing battery.

To achieve the above objective, the present disclosure adopts the following technical solution.

A manufacturing process of a cylindrical battery includes the following steps.

In step S1, a positive sheet tab of the roll core is fixedly connected to the current collector after the roll core is manufactured.

In step S2, a negative electrode of the roll core is fixedly connected to the conductive elastomer to form the roll core assembly, and the roll core assembly is inserted into the case.

In step S3, after the roll core assembly is inserted into the case, the roll core is fixedly connected to a bottom of the case.

In step S4, the case opening of the case is necked to form the necking and the flange, and then the insulating element is placed into the case.

In step S5, the conductive adhesive is coated on an outer wall of the flange.

In step S6, a cap assembly is mounted.

In step S7, the cap assembly and the flange are double-seamed.

In step S8, the battery is baked in vacuum.

In step S9, an electrolyte is injected after baking is completed.

In step S10, the liquid injection sealing pin is welded for sealing after liquid-injecting is completed, to complete battery assembling.

Further, in the step S7, a specific method for double-seaming the cap assembly and the flange of the case is: positioning a matched part between the flange of the case and a seaming edge of the cap above the necking of the case opening, making an outer diameter of a seaming edge of the case opening of the case identical to a diameter of a case body after the double-seaming.

The manufacturing process of the cylindrical battery and the cylindrical battery have the same advantages as those in the prior art. Details are not described herein again.

### BRIEF DESCRIPTION OF THE DRAWINGS

The accompanying drawings which constitute a part of the description of the present disclosure are intended to provide further understanding of the present disclosure. The exemplary embodiments of the present disclosure and descriptions thereof are intended to be illustrative of the present disclosure and do not constitute an undue limitation of the present disclosure. In the accompanying drawings:

FIG. 1 is an exploded view of a cylindrical battery according to an embodiment of the present disclosure;

FIG. 2 is a first schematic diagram of a roll core according to an embodiment of the present disclosure;

FIG. 3 is a second schematic diagram of the roll core according to an embodiment of the present disclosure;

FIG. 4 is a sectional view of a positive sheet according to an embodiment of the present disclosure;

FIG. 5 is a sectional view of a negative sheet according to an embodiment of the present disclosure;

FIG. 6 is a first schematic diagram of a current collector according to an embodiment of the present disclosure.

FIG. 7 is a second schematic diagram of the current collector according to an embodiment of the present disclosure;

FIG. 8 is a top view of a cap assembly according to an embodiment of the present disclosure;

FIG. 9 is a sectional view of the cap assembly along line A-A shown in FIG. 8;

FIG. 10 is a schematic diagram showing a current collector and a positive sheet of a roll core welded together according to an embodiment of the present disclosure;

FIG. 11 is a partial sectional view of FIG. 10;

FIG. 12 is a sectional view showing pressing and heating according to an embodiment of the present disclosure;

FIG. 13 is a sectional view showing a necking and a flange according to an embodiment of the present disclosure;

FIG. 14 is a sectional view showing coating a conductive adhesive according to an embodiment of the present disclosure;

FIG. 15 is an enlarged view of portion B shown in FIG. 14;

FIG. 16 is a sectional view showing a welded cap assembly according to an embodiment of the present disclosure;

FIG. 17 is a sectional view obtained after double-seaming according to an embodiment of the present disclosure;

FIG. 18 is an enlarged view of portion C shown in FIG. 17; and

FIG. 19 is a sectional view of a molded battery according to an embodiment of the present disclosure.

### REFERENCE NUMERALS

1: case; 2, conductive elastomer; 3, roll core; 31, positive sheet; 32, negative sheet; 4, current collector; 41, conductive disc; 42, flange boss; 43, current collector through hole; 5, insulating element; 6, cap assembly; 61, cap; 62, insulated sealing ring; 63, cap groove; 64, cap boss; 65, lower groove; 66, upper groove; 67, post; 68, post central liquid-injecting hole; 69, explosion-proof mechanism; 7, liquid injection sealing pin; 8, pressing tool; 9, heating device; 10, necking; 11, flange; 12, conductive adhesive; and A, tab-free area.

### DETAILED DESCRIPTION OF THE EMBODIMENTS

It should be noted that embodiments in the present disclosure or features in the embodiments may be combined with one another without conflict.

It should be understood that in the description of the present disclosure, terms such as “central”, “longitudinal”, “transverse” “upper”, “lower”, “front”, “rear”, “left”, “right” “vertical”, “horizontal”, “top”, “bottom”, “inside” and “outside” indicate the orientation or position relationships based on the drawings. They are merely intended to facilitate and simplify the description of the present disclosure, rather than to indicate or imply that the mentioned device or components must have a specific orientation or must be constructed and operated in a specific orientation. Therefore, these terms should not be construed as a limitation to the present disclosure. Moreover, terms such as “first” and “second” are used only for the purpose of description and cannot be understood as indicating or implying relative importance or implicitly indicating the number of technical features denoted. Thus, features defined with “first” and “second” may explicitly or implicitly include one or more of the features. In the description of the present disclosure, unless otherwise specified, “a plurality of” means at least two.

In the description of the present disclosure, it should be noted that, unless otherwise clearly specified, meanings of terms “mount”, “connected with”, and “connected to” should be understood in a board sense. For example, the connection may be a fixed connection, a removable connection, or an integral connection; may be a mechanical connection or an electrical connection; may be a direct connection or an indirect connection by using an intermediate medium; or may be intercommunication between two elements. A person of ordinary skill in the art may understand specific meanings of the above terms in the present disclosure based on a specific situation.

The present disclosure will be described in detail below with reference to the accompanying drawings and the embodiments.

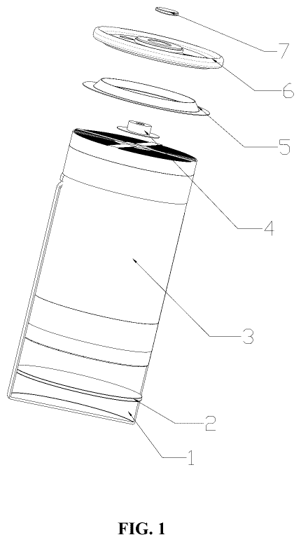

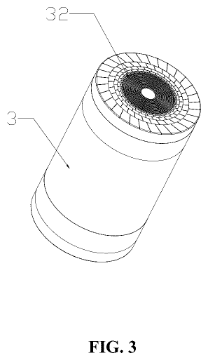

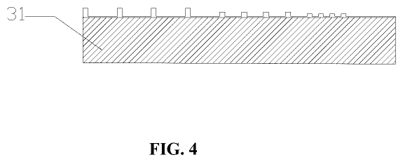

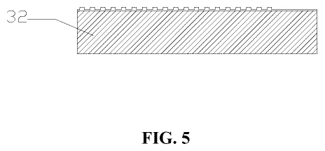

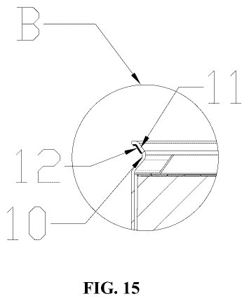

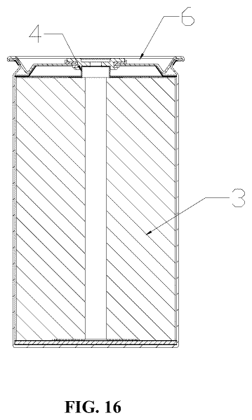

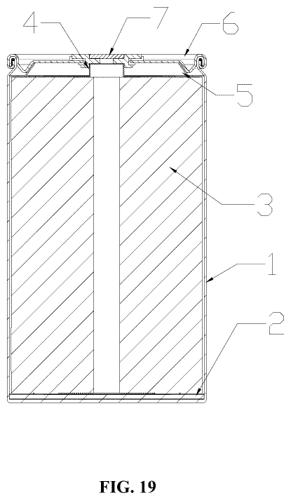

As shown in FIG. 1 to FIG. 19, a cylindrical battery includes a case 1, where a conductive elastomer 2, a roll core 3, a current collector 4, an insulating element 5, a cap assembly 6, and a liquid injection sealing pin 7 are sequentially arranged inside the case 1 from bottom to top; a lower portion of the roll core 3 is fixedly connected to the case 1 via the conductive elastomer 2, an upper portion of the roll core 3 is welded with the current collector 4, an upper portion of the current collector 4 passes through the insulating element 5 and is welded with the cap assembly 6, the insulating element is configured to prevent the cap assembly 6 and the roll core 3 from being short-circuited, and an upper portion of the cap assembly 6 is sealed via the liquid injection sealing pin 7; and a necking 9 and a flange 10 are defined on an outside the case 1, a conductive adhesive layer is arranged on an outside of the flange 10, and seamed parts of the flange 10 and the cap assembly 5 that are double-seamed are positioned above the necking 10, so that an outer diameter of a sealing edge of a case opening of the case is identical to a diameter of a case body. The cylindrical battery is simple in structure, strong in flow-through capability, suitable for large-rate charging and discharging, simple in assembling, high in production efficiency, and low in manufacturing cost. In addition, in this solution, positive and negative electrodes of the battery are positioned on a same side, to facilitate design and welding of an external module or a busbar of a system, and further facilitate a thermal management design for heating/cooling the bottom of a battery cell.

The case 1 is a hollow cylindrical structure with an opening in an end, an outer surface of the case 1 is nickel-plated, and an inner surface of the case 1 can be nickel-plated or copper-plated, preferably copper-plated. Electrochemical corrosion is not generated as the case has no potential difference with copper on the negative electrode, and therefore, electrical conductivity of the case does not change after being used for a long time. The case 1 is the positive electrode, and a copper rod inserted into the roll core 3 is a negative electrode. Both the post 66 and the current collector 3 are positive electrodes.

The conductive elastomer 2 is conductive foam, foamed nickel, foamed copper, or the like. Thermosetting conductive adhesives are coated on the two sides of the conductive elastomer 2, and the thermosetting conductive adhesive may be a silver-series, copper-series or graphite/carbon filled thermosetting conductive adhesive. A curing temperature of the thermosetting conductive adhesive is greater than or equal to 100° C. Preferably, thermosetting conductive adhesive is the graphite/carbon black-filled thermosetting conductive adhesive, which is low in cost and is kept stable in the battery. The insulating element 5 is an insulating ring. The inside and the bottom of the case can be copper-plated, and a negative sheet tab of the battery cell and the copper-plated bottom of the case are bonded via the thermosetting conductive adhesive. Same materials have no potential difference after being bonded, and therefore, electrochemical corrosion is not generated.

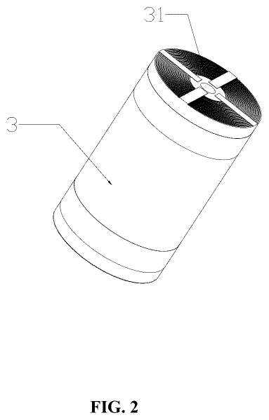

As shown in FIG. 2 to FIG. 5, the negative side of the roll core 3 is of a multi-tab structure, and is formed into a stepped surface after being shaped, so that an area of contact between the thermosetting conductive adhesive in the conductive elastomer 2 and the tab is increased, and electrical-conduction and thermal-conduction performance is improved.

A positive sheet 31 of the roll core 3 is a variable-pitch variable-height tab structure to be cut and bent, and is bent and flattened after being wound. The bent tab is pressed and welded with a circular disc surface of a current collector body 41. This ensures that a maximum-thickness layer of the bent tab is welded with the current collector 4, and a flow-through area is increased. In addition, this tab bending manner facilitates the electrolyte in infiltrating the roll core from the positive side. The tab may be bent into a three-piece tab, a four-piece tab, a six-piece tab, an eighth-piece tab, or the like. A plurality of tabs of the negative sheet 32 is arranged at equal pitch and equal height, and is shaped after being wound. The negative sheet tab of the roll core is of a multi-tab roll core structure, and has an uneven structure on surface, so that a combination area of the thermosetting conductive adhesive is large, and electrical conductivity is good.

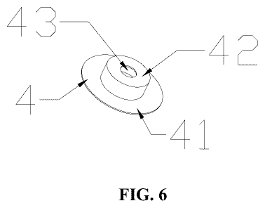

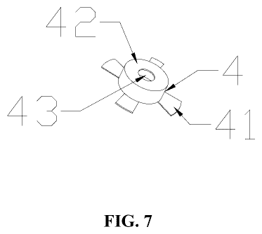

As shown in FIG. 6 and FIG. 7, the current collector 4 includes a conductive disc 41 and a flange boss 42 that are of an integrated structure, where the flange boss 42 is arranged on a middle part of the conductive disc 41, a current collector through hole 43 is defined in a middle part of the flange boss 42, and the current collector through hole 43 is a liquid-injecting hole to facilitate positioning with a post central liquid-injecting hole 68 of the cap assembly 6 and circulate the electrolyte; and the flange boss 42 is arranged to facilitate positioning between the current collector 4 and the cap assembly 6. The structure of the conductive disc 41 does not completely cover the positive sheet tab of the roll core. In addition to welding the positive sheet tab with the circular disc, in the current collector, the flange boss 42 is tightly attached to and welded with the cap and the post, to realize large-area overflowing. In addition, the liquid-injecting hole facilities positioning and liquid-injecting.

In an embodiment, the conductive disc 41 is a circular disc structure. The circular disc structure is welded with the bent tab, and the positive sheet tab of the roll core is not completely covered, thereby facilitating the electrolyte in flowing in from the positive side for infiltrating.

In another embodiment, the conductive disc 41 is of a four-blade structure. Four conductive discs 41 are uniformly distributed in a circumferential direction of the flange boss 42. The four conductive discs 41 are respectively matched and welded with four sides of the bent tab, and do not completely cover the positive sheet tab of the roll core, thereby facilitating the electrolyte in flowing in from the positive side for infiltrating.

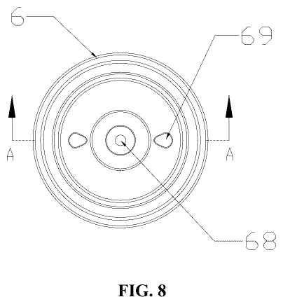

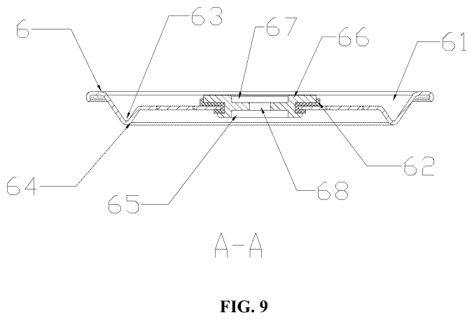

As shown in FIG. 8 and FIG. 9, the cap assembly 6 includes a cap 61, an insulated sealing ring 62, a post 67, and an explosion-proof mechanism 69. A cap groove 63 is defined on an upper portion of the cap 61 for forming a cap boss 64 on a corresponding position of a lower portion of the cap 61, a middle part of the cap 61 is riveted with the post 66, a middle part of the post 66 is defined with a post through hole, and the post 66 and the cap 61 are sealed via the insulated sealing ring 62. The explosion-proof mechanism 67 is arranged on the cap 61 for releasing pressure when the battery is abnormal, to achieve safety protection.

The post through hole includes an upper groove 67, a post central liquid-injecting hole 68, and a lower groove 65 that are of an integrated structure. The upper groove 67 is welded with the liquid injection sealing pin 7 for seaming the battery. The lower groove 65 is configured to be laser-welded with the flange boss 42 of the current collector 4 on the positive electrode for achieving electrical-conduction and thermal-conduction connection. The post central liquid-injecting hole 68 facilitates the roll core 3 in injecting liquid after the seaming, and further facilitates positioning with the current collector through hole 43 and circulating the electrolyte.

The explosion-proof mechanism 69 is an explosion-proof valve or an explosion-proof snick.

The post 66 is configured to be welded with the current collector 4. When the cap 61 is sealed, the cap boss 64 can press the current collector 4 to fasten the roll core 3.

A manufacturing process of a cylindrical battery includes the following steps.

In step S1, positive and negative sheet tabs, and an isolating member are rolled to form a roll core 3. Tabs of a positive sheet 31 are arranged at a variable pitch and a variable height, and are bent and flattened after being wound. This ensures that a maximum-thickness layer of the bent tab is welded with the current collector, and a flow-through area is increased. In addition, this tab bending manner facilitates the electrolyte in infiltrating the roll core from the positive side. Tabs of the negative sheet 32 are arranged at an equal pitch and an equal height, and are shaped after being wound. The negative sheet tab of the roll core is of a multi-tab roll core structure, and has an uneven structure on surface, so that a combination area of the thermosetting conductive adhesive is large, and the electrical conductivity is good.

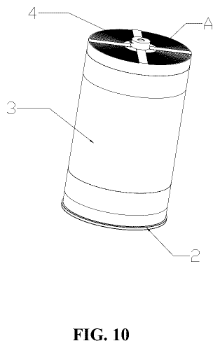

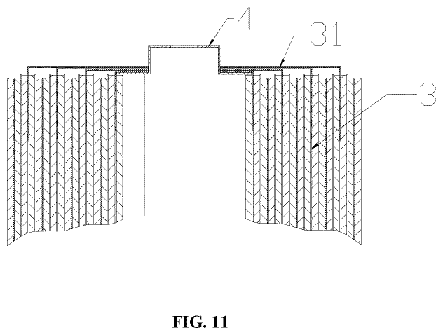

As shown in FIG. 10 and FIG. 11, in step S2, the current collector 4 is welded with the positive sheet tab of the roll core 3. The maximum-thickness layer of the bent tab is welded with the current collector 4 to increase flow-through area. In addition, in this tab bending manner, a tab-free area A facilitates the electrolyte in infiltrating the roll core from the positive side.

In step S3, the negative side of the roll core 3 is pasted with the conductive elastomer 2 coated with the thermosetting conductive adhesives on double sides to form the roll core assembly. The conductive elastomer 2 is conductive foam, foamed nickel, foamed copper, or the like. Thermosetting conductive adhesives are coated on the two sides of the conductive elastomer, and the negative sheet tab of the roll core is of a multi-tab roll core structure, and has an uneven structure on surface, so that a combination area of the thermosetting conductive adhesive is large, and electrical conductivity is good.

In step S4, the current collector-free side of the roll core assembly is inserted into the case 1 from the opening side of the case 1, and the thermosetting conductive adhesive of the conductive elastomer 2 is tightly pasted and matched with the bottom of the case 2. The thermosetting conductive adhesive may be a silver-series, copper-series or graphite/carbon black-filled thermosetting conductive adhesive, is low in cost and is kept stable in the battery. In addition, the bottom of the case may be nickel-plated or copper-plated, preferably copper-plated. Electrochemical corrosion is not generated as the case has no potential difference with copper on the negative electrode, and therefore, conductivity of the case does not change after being used for a long time.

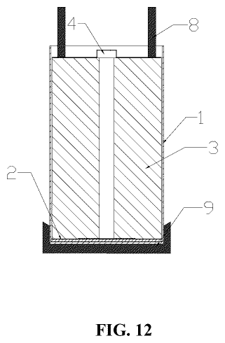

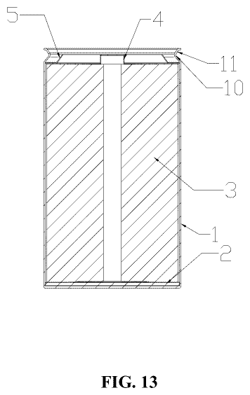

As shown in FIG. 12 and FIG. 13, in step S5, after the roll core 3 is inserted into the case, the roll core 3 is pressed from the top of the opening of the case 1 via a pressing tool 8, and the bottom of the case 1 is heated via a heating device 9 at a heating temperature greater than or equal to 100° C., so that the conductive adhesive is heated and cured to ensure that the roll core 3 is firmly bonded with the bottom of the case.

In step S6, the case opening, on the positive side of the roll core 3, of the case 1 is necked to form a necking 10 and a flange 11, and then the insulating element 5 is arranged in the case. The battery structure is sealed in a double-seaming manner, and the case opening is necked to ensure that a diameter of the case opening is identical to a diameter of a case body after the seaming. If the case opening is not necked, the diameter of the case opening of the battery is greater than that of the case body after the seaming. When PACK is assembled, failure in mounting or inconvenience is caused. The flange is to fit the cap, to facilitate performing double-seaming smoothly. After the necking and the flange are formed, the insulating element 5 is arranged in the case to prevent the cap boss 64 from directly pressing the positive sheet tab of the roll core 3 to avoid being short-circuited after the cap is mounted.

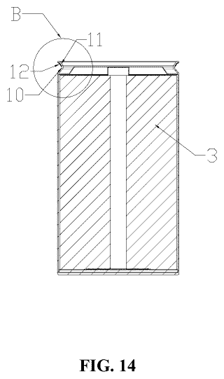

As shown in FIG. 14 to FIG. 16, in step S7, a conductive adhesive 12 is coated on the back of the flange 11 of the case opening. The conductive adhesive 12 has the effect of seaming for sealing after the cap 61 is mounted, and further has the effect of improving electrical conductivity after the cap 61 is seamed with the bottom of the case.

In step S8, the cap assembly 6 is mounted, and the lower groove 65 of the cap assembly 6 is inserted into the flange boss of the current collector 4 for laser circumferential welding after being pressed, to implement thermal conduction and thermal conduction between a positive post 66 and the positive sheet tab of the roll core.

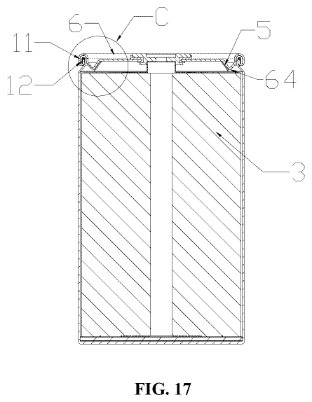

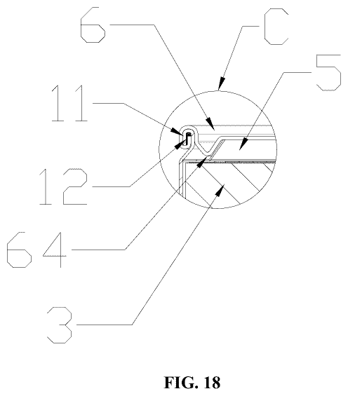

As shown in FIG. 17 and FIG. 18, in step S9, a specific method for performing double-seaming on the cap assembly and the flange of the case is: A matched part between the flange of the case and a seaming edge of the cap is positioned above the necking of the case opening, so that an outer diameter of the sealing edge of the case opening of the case is identical to a diameter of the case body after double-seaming is performed. The cap 61 of the battery and the case opening are double-seamed, so that on one hand, the device is manure and production efficiency is high, on the other hand, leak-proofness is good, and the electrolyte is ensured to not leak from the battery. A cap boss 64 of the double-seamed battery presses the insulating element 5 to press the roll core 3, to ensure that the roll core 3 does not shake in the case 1, and prolong a service life of the battery.

In step S10, the seamed battery is put into a vacuum oven to bake at a baking temperature greater than or equal to 100° C., so that on one hand, the tab of the roll core 3 is heated and baked to remove moisture, on the other hand, the conductive adhesive 12 is cured through baking. In this way, the seamed part can be better sealed and conducted, to improve contact electrical conductivity and leakage-proofness after the cap and the flange of the case are double-seamed.

In step S11, after the baking is completed, the electrolyte is injected from the post central liquid-injecting hole 68.

In step S12, after the liquid injecting is completed, the liquid injection sealing pin 7 is welded for seaming, to complete assembling of the battery.

In this solution, the current collector is cancelled for the tab on one side, and the conductive elastomer and thermosetting conductive adhesives coated on two sides are cured to connect the negative sheet tab of the battery cell to the case, so that assembling is simple with high assembling efficiency. In addition, a large thermal-conduction and thermal-conduction area facilitates large-power use of the battery. Preferably, the thermosetting conductive adhesive is the graphite-filled thermosetting conductive adhesive that is low in cost, is stable in an electrolyte environment, and is reliable in electrical conductivity for a long time.

The above described are merely preferred embodiments of the present disclosure, and not intended to limit the present disclosure. Any modifications, equivalent replacements and improvements made within the spirit and principle of the present disclosure should all fall within the scope of protection of the present disclosure.

What is claimed is:

1. A cylindrical battery, comprising a case, a conductive elastomer, a roll core, a current collector, an insulating element, a cap assembly, and a liquid injection sealing pin, wherein the conductive elastomer, the roll core, the current collector, the insulating element, the cap assembly, and the liquid injection sealing pin are sequentially arranged inside the case from bottom to top; a lower portion of the roll core is fixedly connected to the case via the conductive elastomer, an upper portion of the roll core is welded with the current collector, an upper portion of the current collector passes through the insulating element and is welded with the cap assembly, the insulating element is configured to prevent the cap assembly and the roll core from being short-circuited, and an upper portion of the cap assembly is sealed via the liquid injection sealing pin; and a necking and a flange are defined on an outside of the case, a conductive adhesive layer is arranged on an outside of the flange, and the flange and the cap assembly are double-seamed, seamed parts of the flange and the cap assembly are positioned above the necking, so that an outer diameter of a sealing edge of a case opening of the case is identical to a diameter of a case body of the case.

2. The cylindrical battery according to claim 1, wherein thermosetting conductive adhesive layers are arranged on two sides of the conductive elastomer.

3. The cylindrical battery according to claim 1, wherein a positive sheet tab of the roll core is of a variable-pitch variable-height tab structure capable of being cut and bent, and is bent and flattened after being wound.

4. The cylindrical battery according to claim 1, wherein a negative sheet tab of the roll core is of an equal-pitch equal-height multi-tab roll core structure.

5. The cylindrical battery according to claim 1, wherein the current collector comprises a conductive disc and a flange boss that are of an integrated structure, the flange boss is arranged on a middle part of the conductive disc, a current collector through hole is defined in a middle part of the flange boss, and a sectional area of the conductive disc is smaller than that of the positive sheet tab of the roll core.

6. The cylindrical battery according to claim 1, wherein the cap assembly comprises a cap and a post, a cap groove is defined on an upper portion of the cap for forming a cap boss on a corresponding position of a lower portion of the cap, a middle part of the cap is riveted with the post, a middle part of the post is defined with a post through hole, and the post and the cap are sealed via an insulated sealing ring.

7. The cylindrical battery according to claim 6, wherein the post through hole comprises an upper groove, a post central liquid-injecting hole, and a lower groove that are of an integrated structure, and the upper groove is welded with the liquid injection sealing pin.

8. The cylindrical battery according to claim 6, wherein an explosion-proof mechanism is arranged on the cap.

9. A manufacturing process of the cylindrical battery according to claim 1, comprising the following steps:
S1, fixedly connecting a positive sheet tab of the roll core to the current collector after the roll core is manufactured;
S2, fixedly connecting a negative electrode of the roll core to the conductive elastomer to form the roll core assembly, and inserting the roll core assembly into the case;
S3, after inserting the roll core into the case, fixedly connecting the roll core to a bottom of the case;
S4, necking the case opening of the case to form the necking and the flange, and then placing the insulating element into the case;
S5, coating the conductive adhesive on an outer wall of the flange;
S6, mounting the cap assembly;
S7, double-seaming the cap assembly and the flange of the case;
S8, baking the battery in vacuum;
S9, injecting an electrolyte after baking is completed; and
S10, welding the liquid injection sealing pin for sealing after liquid-injecting is completed, to complete battery assembling.

10. The manufacturing process of the cylindrical battery according to claim 9, wherein in the step S7, a specific method for double-sealing the cap assembly and the flange of the case is: positioning a matched part between the flange of the case and a seaming edge of the cap above the necking of the case opening, making an outer diameter of a seaming edge of the case opening of the case identical to a diameter of the case body after the double-seaming.
